(19) United States
(12) Patent Application Publication
(10) Pub. No.: US 2005/0204888 A1
(43) Pub. Date: Sep. 22, 2005

(54) Cutting guide

(75) Inventors: Roland Fries, Cincinnati, OH (US); W. Ted Martin JR., Cincinnati, OH (US)

Correspondence Address: WOOD, HERRON & EVANS, LLP, 2700 CAREW TOWER, 441 VINE STREET, CINCINNATI, OH, 45202, US

(73) Assignee: GD Tools, LLC, Cincinnati, OH (US)

(21) Appl. No.: 11/061,428

(22) Filed: Feb. 18, 2005

Related U.S. Application Data
(63) Continuation-in-part of application No. 10/801,278, filed on Mar. 16, 2004.

(51) Int. Cl. B27B 11/00

(52) U.S. Cl. 83/745; 83/574; 83/581

(57) ABSTRACT

A cutting guide for effecting straight accurate cuts along a workpiece includes a clamp, a saw guide pivotally coupled to the clamp and having a guiding edge for bearing support for a portion of the saw so as to guide the saw during the cutting operation of the workpiece, and a cutting template. The cutting template is cuttable so as to produce a template cutting edge on a first template portion and a second discard portion. The template cutting edge identifies the position of the guiding edge relative to a cut line for a specific saw and for a specific angled cut. The cutting template may be used to cut subsequent workpieces having the same cut configuration and using the same saw. A user may have a plurality of cutting templates, each having a different first template portion configuration.

This application is a continuation-in-part of U.S. application Ser. No. 10/801,278, filed on Mar. 16, 2004 and hereby incorporated by reference entirely.

### FIELD OF THE INVENTION

This invention relates to saws, and more particularly, to a cutting guide for effecting a straight and accurate cut along a workpiece.

### BACKGROUND OF THE INVENTION

Power saws, such as circular saws, jig saws, miter saws and other saws are used extensively for cutting wood and other types of materials. When doing so, the cutting operation should be performed as accurately and safely as possible. In many instances, the cutting operation is to be performed along one or more straight line segments on a workpiece and therefore, performing straight cuts is essential to high quality carpentry and construction.

Guides that cooperate with the saw so as to execute a straight cut along a workpiece are generally well known. The guide helps to reduce the inaccuracies or errors that would otherwise result if the saw inadvertently moved or bumped during the cutting operation. Power saws generally include a housing in which an electrical motor is mounted and the motor in turn is operatively connected to an arbor on which the saw blade is mounted. For many types of saws, the saw further includes a saw plate or shoe that provides an opening through which the saw blade projects. The saw plate also supports the saw when positioned on a workpiece. A side edge of the saw plate is generally parallel to the saw blade and at a predetermined, fixed distance from the saw blade. The side edge of the saw plate is often used as a bearing surface against an edge of the saw guide during the cutting operation. The contact between the side edge of the saw plate and the edge of the saw guide keeps the blade of the saw along a straight path.

When a workpiece, such as a plank, a trim member or a 2×4, must be cut to a particular length, the length of the piece to be cut is measured, and then cut. When measuring a workpiece, the position of the cut line is identified and marked, such as, for example, by using a T-square and a pencil to trace the straight cut line, by laying down a chalk line to mark the cut line or by other means known in the art. The cut line, however, identifies the path of the saw blade, thus when using a guide, one must compensate for the position of the saw blade relative to the position of the bearing edge of the saw plate. In other words, one must measure from the cut line to account for the spacing between the side edge of the saw plate which abuts the saw guide and the position of the blade.

The distance between the saw blade and the side edge of the saw plate, hereafter referred to as the offset, is generally not a standard width and typically depends on not only the type of saw one is using for the cutting operation but also on the make and model of a particular type of saw. Thus the offset must be measured for the particular saw being used to make the desired cut. A second mark is then made on the workpiece at a distance from the desired cut line that corresponds to the offset for the saw being used to make the cut. In this way, when the saw is placed on the workpiece and the side edge of the saw plate positioned against an edge of the saw guide, the saw blade aligns with the desired cut line.

It is evident from the above description, however, that these calculations become quite tedious and prone to errors in the cutting process, especially when numerous workpieces having generally the same dimension must be cut. These drawbacks are exacerbated when a variety of different saws or models are used.

As such, a need exists for a cutting guide that reduces the potential for errors and inaccuracies when determining the position of the saw guide relative to the position of the desired cut line.

### SUMMARY OF THE INVENTION

This invention provides a cutting guide that overcomes the above-mentioned and other problems by quickly and accurately locating the position of the saw guide relative to the cut line. The cutting guide includes a clamp, a saw guide pivotally coupled relative to the clamp and adapted to be juxtaposed to a surface of the workpiece, a guiding edge on the saw guide providing a bearing support to a portion of the saw so as to guide the saw during the cutting of the workpiece, and a cutting template coupled to the cutting guide and adapted to be juxtaposed to the surface of the workpiece. The cutting template is cuttable along a cut line so as to produce a template cutting edge. The template cutting edge identifies the position of the guiding edge of the saw guide relative to a cut line on the workpiece.

In one embodiment, the clamp includes a first clamping member fixedly secured to a lock bar extending from the first clamping member. A second clamping member is slidably coupled to the lock bar and is moveable so as to clamp varying sized workpieces therebetween. The second clamping member may be a quick release type with a handle having a first and second position. When the handle is in the first position the second clamping member is secured to the lock bar. When the handle is in the second position, the second clamping member is free to move along the lock bar. The cutting template may be fixedly secured to the clamp, such as with adhesives, or releasably secured thereto, such as by a tongue and groove connection between the first clamping member and the cutting template. In this way, a cutting template may be quickly and easily removed or inserted into the cutting guide. The saw guide may also be coupled to the clamp, such as at the first clamping member, and pivotally moveable between a plurality of positions. In one such position, the guiding edge of the saw guide is spaced from and generally parallel to the template cutting edge. To releasably secure the saw guide relative to the clamp, the saw guide includes a detent and the cutting template includes a plurality of recesses. The saw guide may be so secured when the detent engages one of the recesses.

In use, a user must first cut an uncut cutting template to form the template cutting edge and its associated first template portion that is saw and angle specific. To this end, the guiding edge of the saw guide is aligned relative to the cut line on the workpiece so as to account for the saw offset. If the cut line is angled, then the saw guide must be pivotally moved to correspond to the desired cut line angle. The cutting guide is then releasably clamped to the workpiece. A portion of the saw is then abutted against the guiding edge of the saw guide and moved along the guiding edge during the cutting operation. During the cutting operation, the saw cuts through both the workpiece and the cutting template and thereby forms the template cutting edge and its associated first template portion that is saw and angle specific. A second portion of the cutting template is simply discarded.

The as-formed cutting template may then be used to cut subsequent workpieces using the same saw and at the same angle without measuring or accounting for the saw offset. To this end, the cutting edge of the template is aligned with the desired cut line on the workpiece. The cutting guide is then releasably clamped to the workpiece. A portion of the saw is then abutted against the guiding edge of the saw guide and moved along the guiding edge during the cutting operation. During the cutting operation, the saw cuts through only the workpiece along the desired cut line. A user could have a plurality of cutting templates, each template having a different first portion configuration corresponding to different saws and different angled cuts.

In another embodiment of the invention, the cutting template may be coupled to the saw guide instead of the clamp. For example, the cutting template may be fixedly secured to the saw guide or releasably secured thereto, such as by a tongue and groove connection. In this way, a cutting template may be quickly and easily removed or inserted into the cutting guide. When the cutting template is coupled to the saw guide, the template cutting edge does not move relative to the saw guide as the saw guide is moved between the plurality of positions. This advantageously eliminates the need to have separate cutting templates corresponding to different angled cuts. In this case, it is contemplated that a user would have a plurality of cutting templates, each having a different first portion configuration corresponding only to different saws.

A clamp that may be used with the cutting guide includes a locking mechanism for securing the second clamping member to the lock bar at desired locations. To this end, the lock bar includes a plurality of teeth along an engaging edge of the lock bar. A hub adjacent the engaging edge is coupled to the second clamping member and is rotatable relative thereto. The hub includes a gear having a plurality of teeth along a tooth-engaging portion and no teeth along a blank portion. A handle is coupled to the hub to allow a user to conveniently rotate the hub and is moveable between a first and second position. In the first position, the teeth along the tooth-engaging portion engage and mesh with the teeth on the engaging edge of the lock bar. In the second position, the blank portion confronts the teeth of the lock bar. The locking mechanism further includes a locking switch coupled to the second clamping member and moveable between a locked and unlocked position. When in the locked position, the locking switch applies a frictional force to the hub that prevents relative movement between the hub and second clamping member. If the locking switch is locked when the respective teeth of the gear and lock bar are engaged, relative movement between the lock bar and second clamping member is prevented. When in the unlocked position, the hub may move relative to the second clamping member.

The features and objectives of this invention will become more readily apparent from the following Detailed Description taken in conjunction with the accompanying drawings.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a perspective view of an exemplary cutting guide in accordance with the invention showing an uncut cutting template;

FIG. 2 is a perspective view of one embodiment of a clamp in accordance with the invention showing a rotary-type locking mechanism and clamp adaptor;

FIG. 3 is a perspective view of the cutting guide of FIG. 1 after the cutting template has been cut to form a first template portion and template cutting edge that is saw and angle specific;

FIG. 4 is a perspective view of a cutting guide showing the cutting template coupling to the clamp with a tongue-and-groove connection;

FIG. 5 is a perspective view of the cutting template of FIG. 3 attached to a second or subsequent workpiece and showing the guiding edge of the saw guide properly positioned by aligning the template cutting edge with a desired cut line;

FIG. 6 is a perspective view of an alternate embodiment of a cutting template of the invention showing the cutting template coupled to the saw guide;

FIG. 7 is a perspective view showing the cutting template coupling to the saw guide by a tongue-and-groove connection;

FIG. 8 shows a perspective view of an embodiment of a clamp that may be used with the cutting guide of the invention;

FIG. 9 is a cross-sectional view of the clamp of FIG. 8 generally along line 9-9 with the locking switch in the unlocked position; and

FIG. 10 is a cross-section view similar to FIG. 9 with the locking switch in the locked position.

### DETAILED DESCRIPTION

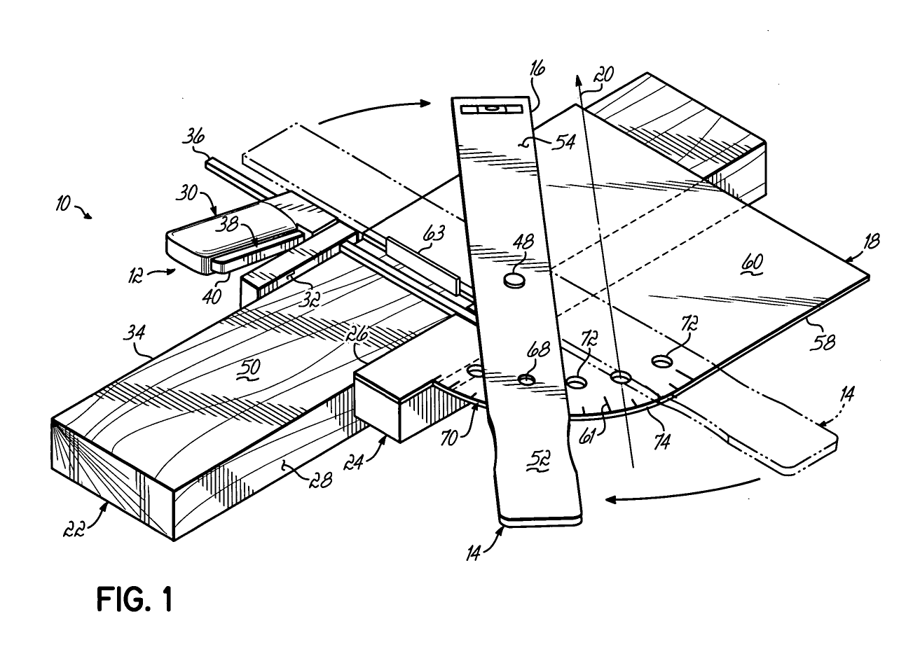

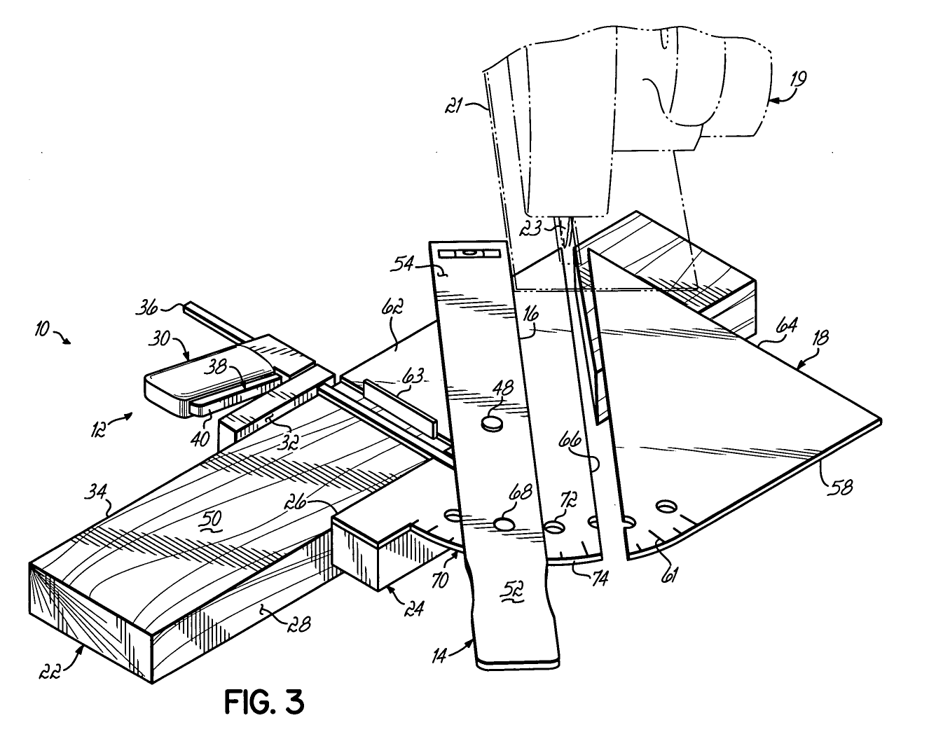

In reference to FIG. 1, an exemplary embodiment of a cutting guide 10 in accordance with the invention is shown. The cutting guide 10 includes a clamp 12, a saw guide 14 pivotally coupled to clamp 12, a guiding edge 16 on saw guide 14, and a cutting template 18 also coupled to clamp 12. The cutting guide 10 is operable for guiding a saw 19 (FIG. 3) along a desired cut line 20 during a cutting operation of a workpiece 22 thereby producing a straight, accurate cut of workpiece 22.

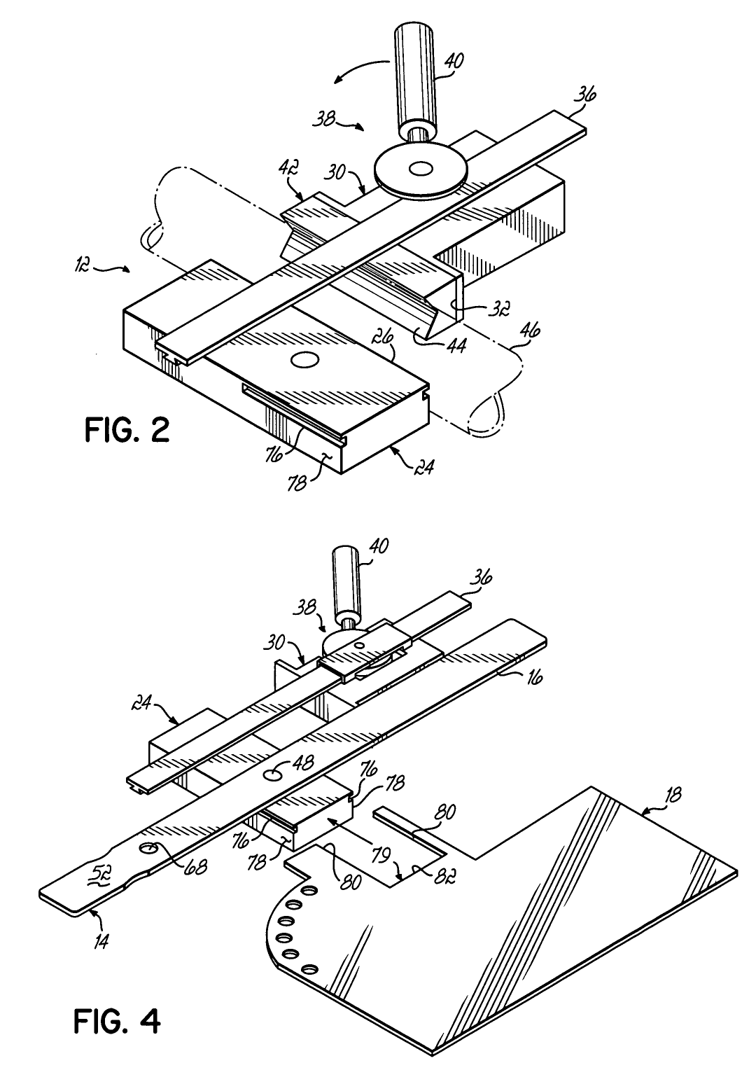

As shown in FIG. 1, the clamp 12 includes a first clamping member 24 having a generally planar clamping surface 26 that abuts a corresponding surface 28 of workpiece 22 and a second clamping member 30 that likewise has a generally planar clamping surface 32 that abuts a corresponding surface 34 of workpiece 22 to thereby secure workpiece 22 between the first and second clamping members 24, 30. The clamp 12 further includes a lock bar 36 extending between first and second clamping members 24, 30. First clamping member 24 is a generally rectangular member fixedly secured to lock bar 36 that provides a base structure for cutting guide 10. Second clamping member 30, however, is generally moveable along lock bar 36 toward and away from the first clamping member 24 so as to accommodate varying sizes of workpieces 22. Second clamping member 30 advantageously includes a quick release locking mechanism 38 for securing the cutting guide 10 to a workpiece 22. By way of example, and as shown in FIGS. 1 and 2, the quick release locking mechanism 38 may be of the trigger type or rotary type. Those of ordinary skill in the art will further recognize other types of locking mechanisms that may also be used in the invention.

In general, however, a quick release mechanism 38 includes a handle 40 moveable between a first and second position. When handle 40 is in the first position, second clamping member 30 is secured to lock bar 36. When handle 40 is in the second position, second clamping member 30 is moveable along lock bar 36 and may be positioned adjacent workpiece 22 so as to secure workpiece 22 between first and second clamping members 24, 30 when handle 40 is moved back to the first position. In the trigger-type of locking mechanism 38 of FIG. 1, handle 40 is moved in a linear fashion to secure or release second clamping member 30 to lock bar 36. In the rotary-type of locking mechanism 38 of FIG. 2, handle 40 is rotated in clockwise/counter-clockwise motion to secure or release second clamping member 30 to lock bar 36.

In reference to FIG. 2, in which like reference numbers refer to like features in FIG. 1, at least one of the clamping members 24, 30 may further include a clamp adaptor 42 that is removably coupled to at least one of the clamping surfaces 26, 32 by known means. Clamp adaptor 42 provides a new clamping surface 44 that is generally non-planar so as to engage a generally non-planar workpiece 46, such as for example a pipe, and thereby enhance the securement of the cutting guide 10 to the non-planar workpiece 46.

With further reference to FIG. 1, saw guide 14 is generally an elongate member pivotally coupled to clamp 12 at pivot point 48. Saw guide 14 may be coupled to clamp 12 by known means including various quick release connections known in the art that facilitate quick and easy attachment/removal of saw guide 14 to or from clamp 12. As shown in FIG. 1, saw guide 14 couples to clamp 12 at first clamping member 24 and is juxtaposed to a top surface 50 of workpiece 22. Saw guide 14 includes a handle portion 52 for easy manipulation by a user and an outer portion 54 that overlies and extends across top surface 50. Saw guide 14 further includes a guiding edge 16 that includes a generally straight or linear portion. Guiding edge 16 is adapted to provide bearing support to a portion of the saw 19, such as the outer edge of the saw plate 21, and thereby guide the saw 19 along the desired cut line 20 during the cutting operation of the workpiece 22 (FIG. 3). By virtue of the pivotal connection at pivot point 48, saw guide 14 is pivotally moveable between a plurality of positions, each position forming a different angle between the guiding edge 16 and workpiece 22. For instance, in one position (shown in phantom), the guiding edge 16 of saw guide 14 is perpendicular to the workpiece 22 while in another position (shown in solid), achieved by rotating the handle portion 52 of saw guide 14 in a clockwise direction, the guiding edge 16 is obliquely angled with respect to the workpiece 22.

In further reference to FIG. 1, cutting template 18 is a generally planar rigid member that may be coupled to clamp 12 at first clamping member 24 and is likewise juxtaposed to a top surface 50 of workpiece 22. Cutting template 18 includes an underside surface 58 that overlies and may rest on top surface 50 of workpiece 22. Saw guide 14 then overlies a top surface 60 of the cutting template 18. Cutting template 18 may further include degree indicia 61 in top surface 60 for indicating the angle of saw guide 14 and guiding edge 16 relative to workpiece 22. A stop member 63 may also be provided to limit the pivotal motion of saw guide 14.

As shown in FIG. 1 and perhaps more clearly in FIG. 3, where like reference numerals refer to like features in FIG. 1, the cutting template 18 is made from a cuttable material, such as plexiglass or various plastic materials, so that when the cutting template 18 is cut along cut line 20, a first template portion 62 that remains coupled to clamp 12 and a second portion 64 that may simply be discarded results. The first template portion 62 includes a template cutting edge 66 that is spaced from and generally parallel to the guiding edge 16 of saw guide 14. The spacing between the guiding edge 16 and template cutting edge 66 corresponds to the offset of the saw 19 used to cut the cutting template 18. In this way, the cutting template 18 then becomes specific to the particular saw 19 used to cut the cutting template 18 and the particular angle saw guide 14 made with workpiece 22 when cutting template 18 was cut. As further explained below, a cutting template 18 that has been cut using a particular saw and at a particular angle may advantageously be used on any subsequent workpieces where it is desired to have the same cut configuration (i.e., angle of the cut) using the same saw.

So that the saw guide 14 does not move during a cutting operation, thereby affecting the accuracy of the cut, the position of the saw guide 14 relative to the cutting guide 10 is releasably fixed. As shown in FIG. 1, one way to do this is to have the saw guide 14 cooperate with cutting template 18 to fix its position. Saw guide 14 includes a detent 68 extending from a bottom surface of the saw guide 14 and toward cutting template 18. Moreover, cutting template 18 includes an arcuate portion 70 having a plurality of recesses 72 spaced along an arcuate path directly below detent 68 so that detent 68 may engage any one of the plurality of recesses 72. When detent 68 engages one of the recesses 72, saw guide 14 becomes releasably secured to cutting template 18 to await any accidental or unintentional movement of saw guide 14. It should be understood that those having skill in the art will recognize additional or alternate configurations for fixing the saw guide 14. For example, the arcuate edge 74 of arcuate portion 70 may include a plurality of v-shaped recesses or notches and the underside of saw guide 14 may include a corresponding v-shaped spring loaded detent or stop member so that when the stop member engages one of the notches, saw guide 14 is fixed relative to the cutting template 18.

The cutting template 18 may be coupled to the cutting guide 10 in a number of ways known in the art. For instance, one way is to adhesively connect the cutting template 18 to first clamping member 24, as shown in FIG. 1. In many cases, however, it is desirable and advantageous to be able to insert and remove a cutting template 18 from cutting guide 10 in a quick and easy fashion. As shown in FIG. 4, another way to connect cutting template 18 to cutting guide 10 is with a tongue and groove connection. First clamping member 24 includes a pair of grooves 76 in side surfaces 78. Moreover, cutting template 18 includes a notch 79 having opposed side walls 80 and base wall 82. To couple cutting template 18 to first clamping member 24, side walls 80 engage openings in grooves 76 and slide along grooves 76 until base wall 82 contacts first clamping member 24. This tongue and groove connection frictionally secures cutting template 18 to cutting guide 10 but permits the quick removal and installation of the cutting template 18.

FIGS. 1, 3 and 5 illustrate how the cutting guide 10 of this invention may be used. As shown in FIG. 1, the cutting template 18 must be cut to form a template cutting edge 66 and its associated first template portion 62 that is saw and angle specific. This is usually done during a cutting operation of the workpiece 22 so as to not waste a cutting operation. Thus when using the cutting template 18 the first time, the position of the guiding edge 16 relative to the desired cut line 20 must be marked. This is usually done by knowing the position of the cut line 20 on the workpiece 22, compensating for the offset in the saw being used to make the cut and marking the position of the guiding edge 16 on workpiece 22. The cutting guide 10 is then releasably clamped on to workpiece 22 so that guiding edge 16 aligns with the guiding edge mark on workpiece 22. The saw blade 23 of the saw 19 should then align with the desired cut line 20. A portion of the saw, such as the edge of the saw plate 21, is then abutted against the guiding edge 16 of saw guide 14 and moved along guiding edge 16 during the cutting operation. For this first time use, the saw 19 cuts through both workpiece 22 and cutting template 18.

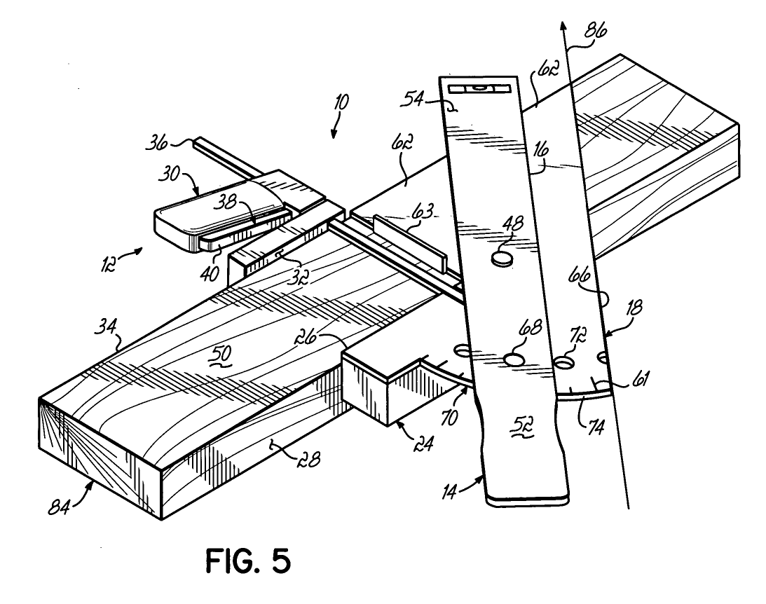

As shown in FIG. 3, this cutting operation produces a cutting template 18 having first template portion 62, second discard portion 64 and template cutting edge 66. The cutting template 18 having first template portion 62 and template cutting edge 66 is then saw and angle specific. Now as shown in FIG. 5, cutting template 18 having first template portion 62 that is saw and angle specific may be advantageously used on subsequent workpieces 84 where it is desired to cut workpiece 84 using the same saw and for the same cut configuration. To do this, the workpiece 84 is measured and the desired cut line 86 is marked on workpiece 84. The cutting guide 10 is positioned on the workpiece 84 so that the template cutting edge 66 aligns with the desired cut line 86. The cutting guide 10 is then releasably clamped to workpiece 84. A portion of the saw 19 is then abutted against the guiding edge 16 of the saw guide 14 and moved along guiding edge 16 during the cutting operation. During the cutting operation, only the workpiece 84 is cut since the cutting template 18 with first template portion 62 has already been formed. Note that the user does not have to compensate for the offset of the saw 19 in that the guiding edge 16 of the saw guide 14 is properly positioned by simply aligning the template cutting edge 66 with the desired cut line 86. This feature is increasingly advantageous when numerous workpieces having the same cut configuration must be made using the same saw. It is contemplated that for this embodiment, a user would have a plurality of cutting templates 18, each template having a different first portion configuration 62 corresponding to different saws and different angled cuts. A user wanting to make a particular cut would then select from the plurality of cutting templates a template having the desired cut configuration and for the specific saw being used to make the cut.

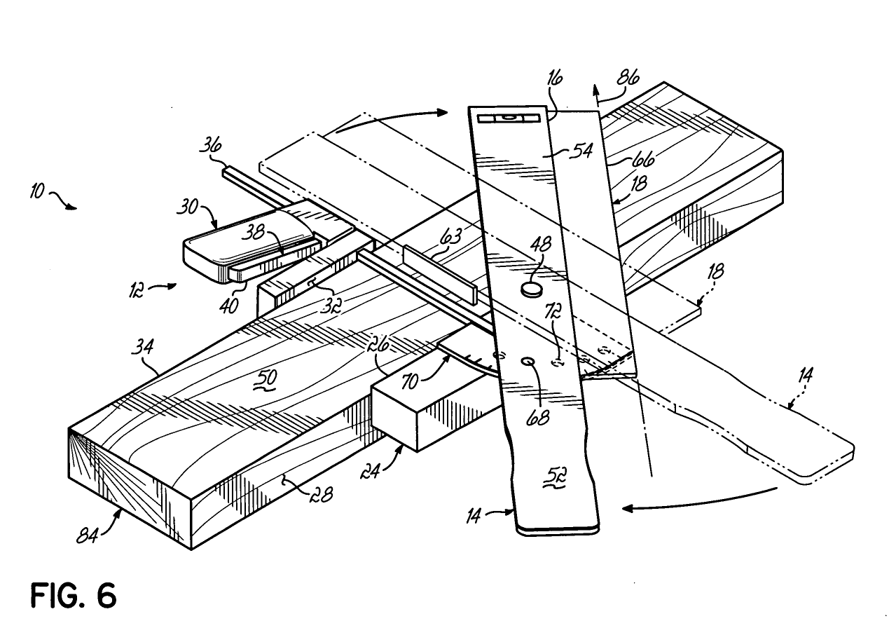

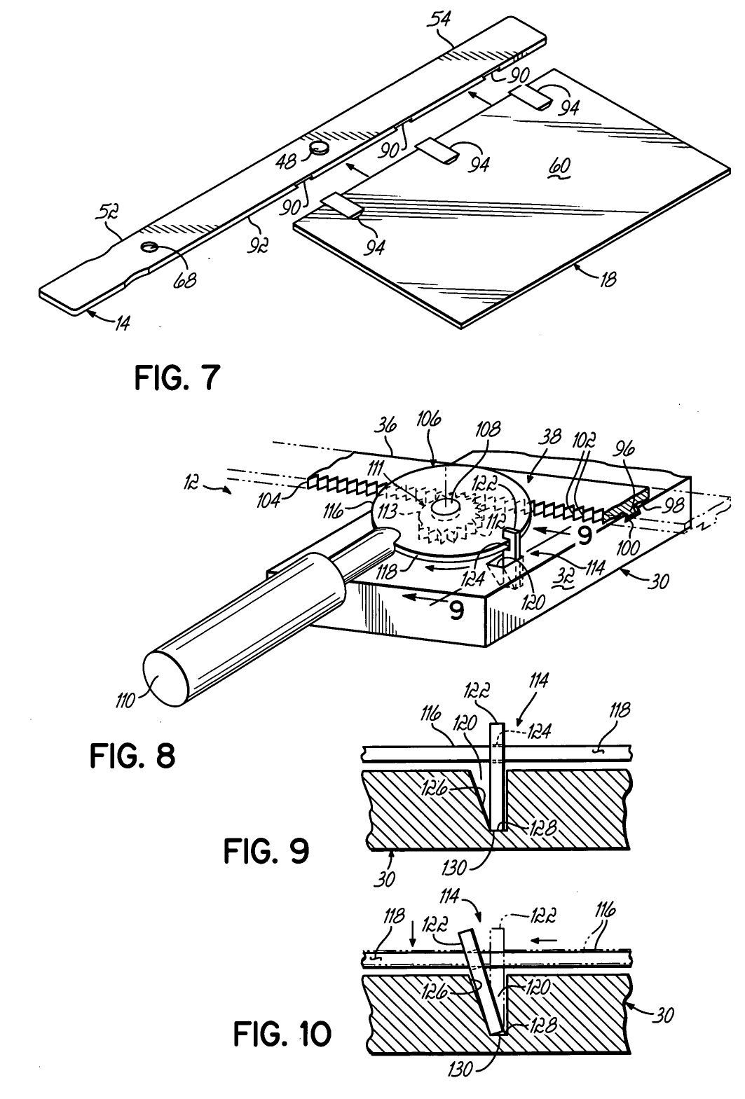

FIGS. 6 and 7 show an alternate embodiment of the cutting guide of the invention. In FIGS. 6 and 7, in which like reference numbers refer to like features in FIGS. 1-5, the cutting template 18 is not coupled to the first clamping member 24, but is instead coupled to the saw guide 14. Coupling the cutting template 18 to the saw guide 14 provides some significant differences in the operation of the cutting guide 10 compared to what is shown and described above. In particular, when the cutting template 18 is coupled to the saw guide 14, the template cutting edge 66 (which is formed in substantially the same manner as described above) does not move relative to the guiding edge 16 as the saw guide 14 is pivotally moved between the plurality of positions. Thus for any possible position of saw guide 14, i.e., for any possible angle that saw guide 14 makes with workpiece 84, the template cutting edge 66 will properly identify the position of guiding edge 16 relative to the cut line 86 for the specific saw used to make template 18. In this way, it is contemplated that a user would not have a plurality of different cutting templates 18 with different first portion configurations 62 corresponding to different angled cuts and to different saws, as described above, but instead a user would have a plurality of cutting templates 18 with different first portion configurations 62 corresponding only to different saws. In other words, by coupling cutting template 18 to saw guide 14, a cutting template 18 now becomes only saw specific, not saw and angle specific, as in the previous embodiment.

The cutting template 18 may be integrally formed with saw guide 14 to form a unitary structure or assembly. For example, the saw guide 14 and cutting template 18 may be integrally molded from a suitable engineering plastic material. In this way, when a user changes saws, the integral saw guide 14 and cutting template 18 may be removed from cutting guide 10 and be replaced by a different saw guide 14 and cutting template 18 that corresponds to the saw that will subsequently be used. Alternately, the saw guide 14 and cutting template 18 may be provided as separate elements or components that are coupled through adhesion or through a frictional fit. For example, as shown in FIG. 7, saw guide 14 may include one or more grooves 90 in the bottom surface 92 of saw guide 14 and cutting template 18 may include a corresponding number of tabs 94 on the top surface 60 of the cutting template 18. The tabs 94 are configured to be slidably received in grooves 90 to releasably secure the cutting template 18 to the saw guide 14. In this way, when a user changes saws, the cutting template 18 may be removed from the saw guide 14 and be replaced by a different cutting template 18 having a first portion configuration 62 that corresponds to the saw that will be subsequently used.

FIGS. 8-10, in which like reference numbers refer to like features in FIGS. 1-5, show an exemplary embodiment of a clamp 12 having a rotary locking mechanism 38 that may be used in the invention. To this end, lock bar 36 includes a rail 96 having a shape, such as a dovetail shape, and extending from a bottom surface 98 of the lock bar 36. Second clamping member 30 includes a recess or channel 100 having a shape complimentary to the shape of the rail 96 on lock bar 36. In this way, second clamping member 30 may be coupled to lock bar 36 but be slidably moveable along rail 96 in a direction toward and away from first clamping member 24 (FIG. 1). Locking mechanism 38, which secures second clamping member 30 at a fixed position along lock bar 36, includes a plurality of teeth 102 along an engaging edge 104 of lock bar 36. Locking mechanism 38 further includes a generally cylindrical hub 106 that is coupled to second clamping member 30, such as by pin 108, but is rotatable relative thereto. Moreover a handle 110 may be provided to help a user rotate hub 106 in a clockwise or counterclockwise direction.

Hub 106 includes a gear 111 having a plurality of teeth 112 along a tooth-engaging portion of the periphery of gear 111 and void of any teeth along a blank portion 113 of the periphery. The blank portion 113 may, for example, include a 90 degree segment of the gear 111. In one handle position, such as when the handle 110 is substantially parallel to the lock bar 36, the blank portion 113 of the gear faces the teeth 102 but does not contact teeth 102. When in such a position, the second clamping member 30 is free to move along lock bar 36. To lock the second clamping member 30 to the lock bar 36, the handle 110 is rotated in one direction, such as a counterclockwise direction. As the handle 110 is rotated, gear 111 is likewise rotated so that teeth 112 engage and mesh with teeth 102 on lock bar 36 to couple hub 106 to lock bar 36.

So as to selectively prevent the second clamping member 30 from moving relative to the first clamping member 24 during use of the cutting guide 10, locking mechanism 38 may further include a locking switch 114 coupled to second clamping member 30. To this end, hub 106 includes a top plate 116, wherein locking switch 114 is located along a periphery 118 of top plate 116. Second clamping member 30 includes a recess 120 into which a switch element 122 is inserted. Switch element 122 includes a cutout 124 into which a peripheral portion of top plate 116 is received so as to retain switch element 122 in recess 120. Switch element 122 is moveable, such as by a user, between a locked and unlocked position. In the unlocked position (FIG. 9), hub 106 may be rotated relative to second clamping member 30, and in the locked position (FIG. 10), switch 122 applies a force to top plate 116 that prevents inadvertent rotation of hub 106 relative to second clamping member 30.

To this end, recess 120 includes a side wall 126 that is obliquely angled with respect to a base wall 128 of the recess 120. This configuration allows switch 122 to pivot about a bottom edge 130 within recess 120 between the locked and unlocked positions. To secure second clamping member 30 to lock bar 36, a user would turn the handle in a counterclockwise direction to engage teeth 102 with teeth 112. As the teeth are engaging each other, the user would then flip the switch element 122 in the clockwise direction to the locked position. When in the locked position, switch element 122 applies a frictional force tangential to top plate 116 so as to resist inadvertent rotation of handle 110 relative to second clamping member 30. Since teeth 102 and 112 are engaged undesirable movement of the second clamping member 30 relative to the first clamping member 24, which would loosen the clamp 12 from the workpiece 84, is prevented. To unlock the locking mechanism 38 and allow movement of second clamping member 30 along lock bar 36, a user would flip the switch element 122 in the counterclockwise direction and then turn the handle 110 in a clockwise direction. This removes the tangential frictional force so that hub 106 is can move relative to second clamping member 30 and allows the handle 110 to be moved so that blank portion 113 faces teeth 102 allowing second clamping member 30 to move relative to first clamping member 24 and along lock bar 36.

Another embodiment of a clamp similar that described above may be readily attained by substituting a hard rubber disk for gear 111 on hub 106. The hard rubber disc does not include any teeth along its periphery. Additionally, teeth 102 on the engaging edge 104 of lock bar 36 are replaced by a roughened surface. The engaging edge 104 may, for example, be roughened by knurls or other roughening patterns or elements. Second clamping member 30 may also include a support wall that engages and contacts an edge of lock bar 36 opposite to the engaging edge 104. In this way, the rubber disk is adapted to engage the lock bar 36, as will be explained below, and frictionally secure lock bar 36 between the rubber disc and the support wall. The frictional force then secures second clamping member 30 to lock bar 36.

It is desirable that when locking mechanism 38 is in an unlocked position, such that second clamping member 30 is free to move along lock bar 36, the rubber disk and roughened engaging edge 104 do not engage one another. To this end, pin 108 is not located at the geometric center of hub 106, but instead is positioned slightly off center and toward locking bar 36. This eccentric configuration advantageously allows the rubber disc on hub 106 to engage roughened engaging edge 104 on lock bar 36 when the handle 110 is moved in one direction, such as the counterclockwise direction. This eccentric configuration further advantageously allows the rubber disc on hub 106 to disengage roughened engaging edge 104 on lock bar 36 when the handle 110 is moved in the opposite direction, such as the clockwise direction, so as to permit movement of second clamping member 30 along lock bar 36. This alternate embodiment of the clamp may or may not include the locking switch 114, as previously described. It is contemplated that the friction created between the rubber disc and lock bar 36 and the support wall and lock bar 36 is sufficient to lock the second clamping member 30 to lock bar 36. However, locking switch 114 may be included to further secure second clamping member 30 to lock bar 36.

The invention as described herein has a number of advantages. The primary advantage is that, after the cutting template 18 is cut to produce the template cutting edge 66 on first template portion 62, a user no longer has to know or mark the position of the guiding edge 16 of the saw guide 14, but must only know the position of the cut line 86, which is the normal course of cutting operations. Removing this step greatly reduces the errors and mistakes made when compensating for the offset in the saw being used to make the cut. This also reduces the time to make the cuts on a workpiece, especially when there are numerous workpieces having the same type of cut configuration. Another advantage of the present invention is that because the cutting guide 10 is clamped onto the workpiece, the user may use two hands when operating the saw 19. This then allows a user to make a safer cut without sacrificing cutting accuracy. The safety of cutting operations is also improved by providing a rigid platform from which to start the cutting operation. In many instances, carpenters and other users do not have a platform or starting surface for which to operate the saw, such as a circular saw, before engaging the workpiece. In this invention, the cutting template 18 is sized to provide a platform for operating the saw prior to engaging the workpiece. This makes the entry into the workpiece cleaner and reduces the likelihood of the workpiece “kicking” or presenting other safety hazards.

The cutting guide 10 may also include other features frequently used in woodworking and construction applications. For instance, the saw guide may include a level indicator for gaging the orientation of the saw guide. Moreover, the saw guide and first clamping member may be configured to be in perpendicular relation to each other. When so configured, the cutting guide may also be used as a T-square. The saw guide and/or first clamping member may then include ruler markings or indicia of length typically found on a carpenter's square.

While this invention has been illustrated by the description of the various embodiments thereof, and while the embodiments have been described in considerable detail, it is not intended to restrict or in any way limit the scope of the appended claims to such detail. For instance, it should be understood that while the illustrated embodiments show a cutting guide directed towards cutting operations from left to right when the saw guide is angled, the cutting guide may also be configured to make cuts from right to left when the saw guide is angled.

Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of the general inventive concept.

1. A cutting guide for guiding a saw along a cut line during a cutting operation of a workpiece, the cutting guide comprising:
a clamp;
a saw guide pivotally coupled relative to said clamp and adapted to be juxtaposed to a surface of the workpiece;
a guiding edge on the saw guide adapted to provide bearing support to a portion of the saw and thereby guide the saw along the cut line during the cutting operation of the workpiece; and
a cutting template coupled to said cutting guide and adapted to be juxtaposed to the surface of the workpiece, said cutting template being cuttable by the saw along the cut line to produce a template cutting edge on a first template portion of the cutting template and a second discard portion of the cutting template.

2. The cutting guide of claim 1 wherein said clamp comprises a first and second clamping member, said clamping members adapted to secure the workpiece therebetween.

3. The cutting guide of claim 2 wherein said clamp further comprises a lock bar, said first clamping member being fixedly secured to said lock bar, said second clamping member being slidably coupled to said lock bar.

4. The cutting guide of claim 3 wherein said second clamping member includes a handle moveable between a first and second position, said second clamping member being secured to said lock bar when said handle is in the first position, said second clamping member being moveable along said lock bar when said handle is in the second position.

5. The cutting guide of claim 1 wherein at least one of said first and second clamping members includes a clamp adaptor coupled thereto and configured to securely engage a non-planar workpiece.

6. The cutting guide of claim 1 wherein said saw guide is pivotally moveable between a plurality of positions, said guiding edge of said saw guide being spaced from and generally parallel to the template cutting edge when the saw guide is in at least one of said positions.

7. The cutting guide of claim 1 wherein said saw guide is pivotally mounted to said clamp.

8. The cutting guide of claim 1 wherein said saw guide includes a detent, said cutting template includes a plurality of recesses, the position of said saw guide relative to said clamp being releasably secured when said detent engages one of said recesses.

9. The cutting guide of claim 1 wherein said cutting template further comprises degree indicia adapted to indicate an angle of the saw guide relative to the workpiece.

10. The cutting guide of claim 1 wherein said cutting template is coupled to said first clamping member.

11. The cutting guide of claim 10 wherein said cutting template is releasably coupled to said first clamping member by a tongue and groove connection.

12. The cutting guide of claim 1 wherein said cutting template is coupled to said saw guide.

13. The cutting guide of claim 12 wherein said cutting template is releasably coupled to said saw guide by a tongue and groove connection.

14. The cutting guide of claim 1 wherein said cutting template is selectively and releasably coupled to said cutting guide, the cutting guide further comprising a plurality of cutting templates each of which has a different template cutting edge and associated first template portion configuration.

15. The cutting guide of claim 1, wherein said clamp comprises:
a first clamping member;
a second clamping member;
a lock bar extending between said first and second clamping members, said first clamping member being fixedly secured to said lock bar, said second clamping member being slidably coupled to said lock bar; and
a locking mechanism to secure said second clamping member to said lock bar at a desired location, said locking mechanism comprising:
a plurality of teeth positioned along an engaging edge of said lock bar;
a hub coupled to said second clamping member and being rotatable relative to said second clamping member, said hub including a gear having a plurality of teeth along a tooth-engaging portion and a lack of teeth along a blank portion, said hub further having a handle moveable between a first and second position, said teeth engaging said teeth on said lock bar when said handle is in the first position, said blank portion confronting said teeth on said lock bar when said handle is in the second position; and
a locking switch coupled to said second locking member and moveable between a locked position and an unlocked position, said locking switch applying a frictional force to said hub to prevent movement of said second clamping member relative to said lock bar when in the locked position, said locking switch allowing movement of second clamping member relative to said lock bar when in the unlocked position.

16. A cutting guide for guiding a saw along a cut line during a cutting operation of a workpiece, the cutting guide comprising:
a clamp;
a saw guide coupled relative to said clamp and adapted to be juxtaposed to a surface of the workpiece;
a guiding edge on the saw guide adapted to provide bearing support to a portion of the saw and thereby guide the saw along the cut line during the cutting operation of the workpiece; and
a cutting template coupled to said cutting guide and adapted to be juxtaposed to the surface of the workpiece, said cutting template having a template cutting edge spaced apart and generally parallel to the guiding edge.

17. The cutting guide of claim 16 wherein said clamp comprises a first and second clamping member, said clamping members adapted to secure the workpiece therebetween.

18. The cutting guide of claim 17 wherein said clamp further comprises a lock bar, said first clamping member being fixedly secured to said lock bar, said second clamping member being slidably coupled to said lock bar.

19. The cutting guide of claim 18 wherein said second clamping member includes a handle moveable between a first and second position, said second clamping member being secured to said lock bar when said handle is in the first position, said second clamping member being moveable along said lock bar when said handle is in the second position.

20. The cutting guide of claim 16 wherein said saw guide is pivotally moveable between a plurality of positions, said guiding edge of said saw guide being spaced from and generally parallel to the template cutting edge when the saw guide is in one of said positions.

21. The cutting guide of claim 16 wherein said saw guide includes a detent, said cutting template includes a plurality of recesses, the position of said saw guide relative to said clamp being releasably secured when said detent engages one of said recesses.

22. The cutting guide of claim 16 wherein said cutting template further comprises degree indicia adapted to indicate an angle of the saw guide relative to the workpiece.

23. The cutting guide of claim 16 wherein said cutting template is coupled to said first clamping member.

24. The cutting guide of claim 23 wherein said cutting template is releasably coupled to said first clamping member by a tongue and groove connection.

25. The cutting guide of claim 16, wherein said cutting template is coupled to said saw guide.

26. The cutting guide of claim 25 wherein said cutting template is releasably coupled to said saw guide by a tongue and groove connection.

27. The cutting guide of claim 16 wherein said cutting template is selectively and releasably coupled to said cutting guide, the cutting guide further comprising a plurality of cutting templates each of which has a different template cutting edge.

28. (canceled)

29. (canceled)

30. (canceled)

31. (canceled)

32. A method of performing a cutting operation along a cut line of a workpiece using a saw, comprising:
aligning a guiding edge of a saw guide relative to the cut line on the workpiece;
releasably clamping a cutting guide to the workpiece; and
cutting the workpiece and a cutting template coupled to the cutting guide along the cut line.

33. The method of claim 32 further comprising:
abutting a portion of the saw to the guiding edge of the saw guide; and
moving the portion of the saw along the guiding edge of the saw guide during the cutting operation.

34. The method of claim 32 further comprising:
measuring the workpiece to identify a position of the saw guide relative to the cut line on the workpiece;
marking the position of the saw guide on the workpiece;
aligning the saw guide with the marked position on the workpiece prior to the clamping step.

35. The method of claim 32 further comprising:
pivoting the saw guide relative to the clamp to thereby change an angle the saw guide makes with the workpiece.

36. (canceled)

37. (canceled)
